(19) United States
(12) Patent Application Publication
(10) Pub. No.: US 2017/0230640 A1
(43) Pub. Date: Aug. 10, 2017

(54) PORTABLE IMAGE DEVICE WITH EXTERNAL DISPLAY

(71) Applicant: Samsung Electronics Co., Ltd., Suwon-si (KR)

(72) Inventors: Ciaran ROCHFORD, Bellevue, WA (US); Philippe HARSCOET, Bellevue, WA (US); Sathya IYER, San Jose, CA (US)

(21) Appl. No.: 15/017,128

(22) Filed: Feb. 5, 2016

(51) Int. Cl. H04N 13/04; G06F 3/01

(52) U.S. Cl. CPC H04N 13/044; G06F 3/012

(57) ABSTRACT

A portable image device and a method for displaying an image on a portable image device are provided. The portable image device includes a housing coupled to a support, a first display disposed within the housing, a second display disposed on an external surface of the housing, and a controller configured to display a first image on the first display, and display a second image on the second display.

### TECHNICAL FIELD

The present disclosure relates to a portable image device apparatus. More particularly, the present disclosure relates to a portable image device apparatus having an external display.

### BACKGROUND

A portable image device displays an image to be viewed by a single user. For example, a portable image device can include a heads-up display or a head-mounted display. In addition, a portable image device may be used in an alternative reality (AR) environment and/or a virtual reality (VR) environment.

A heads-up display can display an image on, in, or through a transparent display where the image is superimposed over a user's current viewpoint which allows the user to simultaneously view the image and the current surroundings.

A head-mounted display (HMD) may include glasses, goggles, or a helmet worn on the head of a user. A HMD may include one or more image sources provided adjacent to or in front of the user's eyes which create a two-dimensional or three-dimensional image. However, a HMD device typically obstructs the user's vision outside of the screen which may prevent the user from viewing the current surroundings as well as interacting within the current environment.

Accordingly, there is a need for a portable image device apparatus for improving a user's interaction with current surroundings while preventing undesirable interruptions. In addition, there is a need for a portable image device apparatus that allows another party to interact with the user while the portable image device is being worn by the user.

### SUMMARY

Aspects of the present disclosure are to address at least the above-mentioned problems and/or disadvantages and to provide at least the advantages described below. Accordingly, an aspect of the present disclosure is to provide an apparatus and method for displaying an image on an external display of a portable image device.

In accordance with another aspect of the present disclosure, a portable image device is provided. The portable image device includes a housing coupled to a support, a first display disposed within the housing, a second display disposed on an external surface of the housing, and a controller configured to display a first image on the first display, and display a second image on the second display.

In accordance with an aspect of the present disclosure, a method of displaying an image on a portable image device is provided. The method includes displaying a first image on a first display of the portable image device, and displaying a second image on a second display of the portable image device, wherein the first display is disposed on an inner surface of a housing of the portable image device, and wherein the second display is disposed on an external surface of the housing of the portable image device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of various embodiments of the present disclosure will be more apparent from the following description taken in conjunction with the accompanying drawings, in which:

FIG. 1 illustrates a perspective view of a portable image device according to various embodiments of the present disclosure;

FIG. 2 is a block diagram illustrating a configuration of a portable image device according to various embodiments of the present disclosure;

FIG. 3 is a flow chart illustrating a method of displaying an image on a display of a portable image device according to various embodiments of the present disclosure;

FIGS. 4-7 illustrate examples of images displayed on a display of a portable image device according to various embodiments of the present disclosure; and

FIG. 8 illustrates an exemplary display of a portable image device according to various embodiments of the present disclosure.

Throughout the drawings, it should be noted that like reference numbers are used to depict the same or similar elements, features, and structures.

### DETAILED DESCRIPTION

Detailed descriptions of various aspects of the present disclosure will be discussed below with reference to the attached drawings. The descriptions are set forth as examples only, and shall not limit the scope of the present disclosure.

The detailed description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Unless defined differently, all terms used in the present disclosure, including technical or scientific terms, have meanings that are understood generally by a person having ordinary skill in the art. Ordinary terms that may be defined in a dictionary should be understood to have the meaning consistent with their context, and unless clearly defined in the present disclosure, should not be interpreted to be excessively idealistic or formalistic.

According to various embodiments of the present disclosure, an electronic device may include communication functionality. For example, an electronic device may be a smart phone, a tablet personal computer (PC), a mobile phone, a video phone, an e-book reader, a desktop PC, a laptop PC, a netbook PC, a personal digital assistant (PDA), a portable multimedia player (PMP), an MP3 player, a mobile medical device, a camera, a wearable device (e.g., a head-mounted device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a digital video disk (DVD) player, an audio, a refrigerator, an air conditioner, a vacuum cleaner, an oven, a microwave oven, a washer, a dryer, an air purifier, a set-top box, a TV box (e.g., SAMSUNG HOMESYNC, APPLE TV, or GOOGLE TV), a gaming console, an electronic dictionary, an electronic key, a camcorder, an electronic picture frame, and/or the like.

According to various embodiments of the present disclosure, an electronic device may be a medical device (e.g., magnetic resonance angiography (MRA) device, a magnetic resonance imaging (MRI) device, computed tomography (CT) device, an imaging device, or an ultrasonic device), a navigation device, a global positioning system (GPS) receiver, an event data recorder (EDR), a flight data recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

Various embodiments of the present disclosure include an apparatus and method for displaying information on an external display of a portable image device.

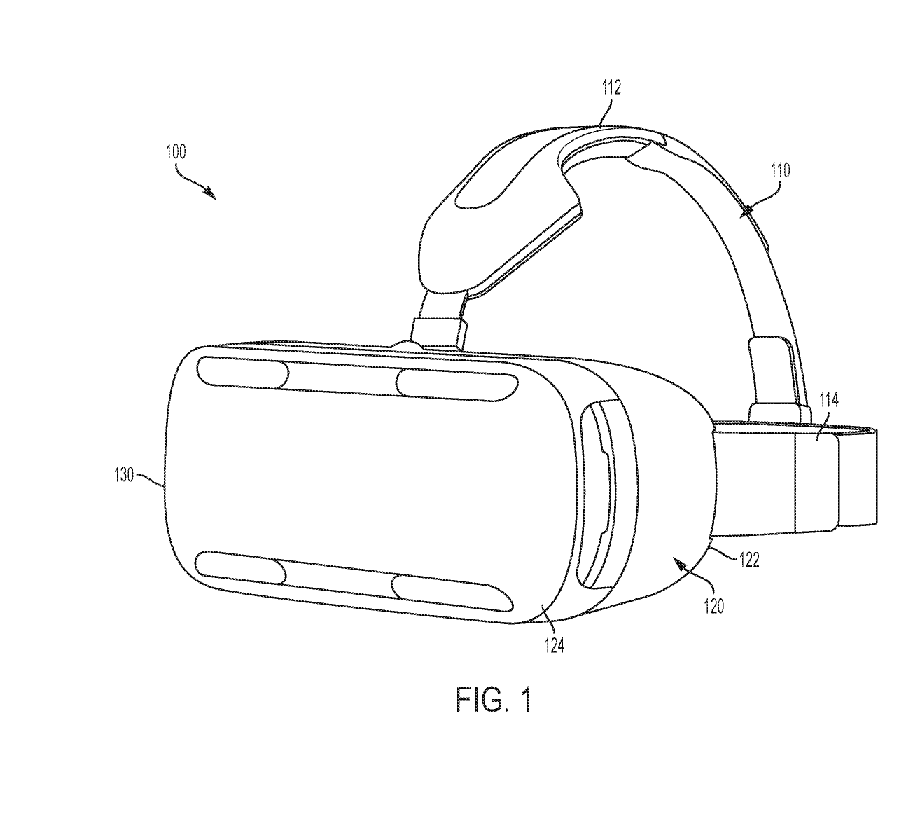

FIG. 1 illustrates a portable image device according to various embodiments of the present disclosure.

Referring to FIG. 1, a portable image device 100 may include a support 110 and a housing 120. The portable image device 100 is an electronic device. While the portable image device 100 is illustrated as a head-mounted display (HMD), the portable image device 100 may be a HMD or a heads-up display including glasses, goggles, and/or a helmet worn on the head of a user. The portable image device 100 may be used in an alternative reality (AR) environment and/or a virtual reality (VR) environment.

The support 110 is configured to secure the portable image device 100 to a user. For example, the support 110 allows the portable image device 100 to be worn and removably coupled to a user. The support 110 may include a head support 112 and/or a strap 114. While FIG. 1 illustrates both the head support 112 and the strap 114, one of ordinary skill in the art would recognize that the portable image device 100 can include one or more support elements where the support elements may have the same or different configurations.

The housing 120 may include a first surface 122 and a second surface 124. In an exemplary embodiment, the first surface 122 may be arranged on an inner portion of the housing 120 such that a portion of the first surface 122 may come in contact with the user's face. For instance, at least a portion of the first surface 122 may come in close contact with the user's face (e.g., around the eyes) where the portion of the first surface 122 may be supported on the user's face. The second surface 124 may be positioned on an external portion of the housing such that the second surface 124 is positioned away from the user's face.

A first display (not illustrated) may be disposed within the housing 120 and a second display 130 may be disposed on a surface of the housing 120. The first display and the second display 130 may be the same or different types of displays.

The first display may be a single display or a plurality of displays configured to display an image to the user. For example, the first display may operate in various modes to generate two-dimensional or three-dimensional images. For example, the first display may include at least one of a display panel, a lens, a laser, and a projector to create a two-dimensional or three-dimensional image including holograms to be viewed by the user.

The second display 116 may be any type of flat panel display such as a liquid crystal display (LCD), an organic light-emitting diode (OLED) display such as an active-matrix OLED (AM-OLED) or other type of OLED display, a plasma display, etc. In an exemplary embodiment, the second display 130 is a touch sensitive display configured to receive touch inputs.

In an exemplary embodiment, the first display may display an image to be viewed by the user and the second display 116 may display an image to be viewed by another party different from the user. The image displayed on the first display may be the same or different from an image on the second display.

For example, a stereo image may be displayed on the first display where an image on a left display is different from an image on a right display. Specifically, the image to be displayed on the left display may have a focal point associated with a left eye of the user and the image to be displayed on the right display may have a focal point associated with the right eye of the user where two different cameras an eye width apart are used to generate the images associated with the left display and the right display. In addition, the image to be displayed on the second display may be generated based on the image displayed on the left display and the right display of the first display where the images displayed on the left display and right display of the first display may create a three-dimensional image and the image displayed on the second display is processed from the two separate inputs associated with the left display and right display to create a two-dimensional image to be displayed on the second display.

For instance, the images displayed on the first display may allow the user to perceive the images from a first-person point of view. An image displayed on the second display may be an image from substantially the same point of view such that the other party different from the user may view substantially the same image as the user. Alternatively, the image displayed on the second display may be from a different point of view of that of the user. For example, an image of the general area surrounding the user within the AR or VR environment may be displayed. In addition, an indicator associated with the user may also be included in the image displayed on the second display to allow the other party different from the user to determine the user's position within the AR or VR environment.

Moreover, the image displayed on the second display may be associated with a first-person point of view different from the user. For example, if the user is within an AR or a VR environment associated with a single shooter game, the image displayed on the first display may be associated with the user's point of view and the image displayed on the second display may be associated with an enemy's first person point of view. However, the image displayed on the first display and the image displayed on the second display may be taken from any point of view including a first person point of view, a third person point of view, or side-to-side scrolling techniques.

In another exemplary embodiment, various attributes associated with the image displayed on the first display may be the same or different from various attributes associated with the image displayed on the second display. For example, the frame rate of the image displayed on the first display may be greater than the frame rate of the image displayed on the second display. Likewise, the pixel density of the image displayed on the first display may be greater than the pixel density of the image displayed on the second display. In addition, the brightness and/or contrast of the image displayed on the first display may be same or different than the brightness and/or contrast of the image displayed on the second display. For example, the brightness and/or contrast of the image displayed on the second display may be greater or less than the brightness and/or contrast of the image displayed on the first display. The brightness and/or contrast of the image displayed on the second display may be based on the ambient light detected in the environment surrounding the portable image device.

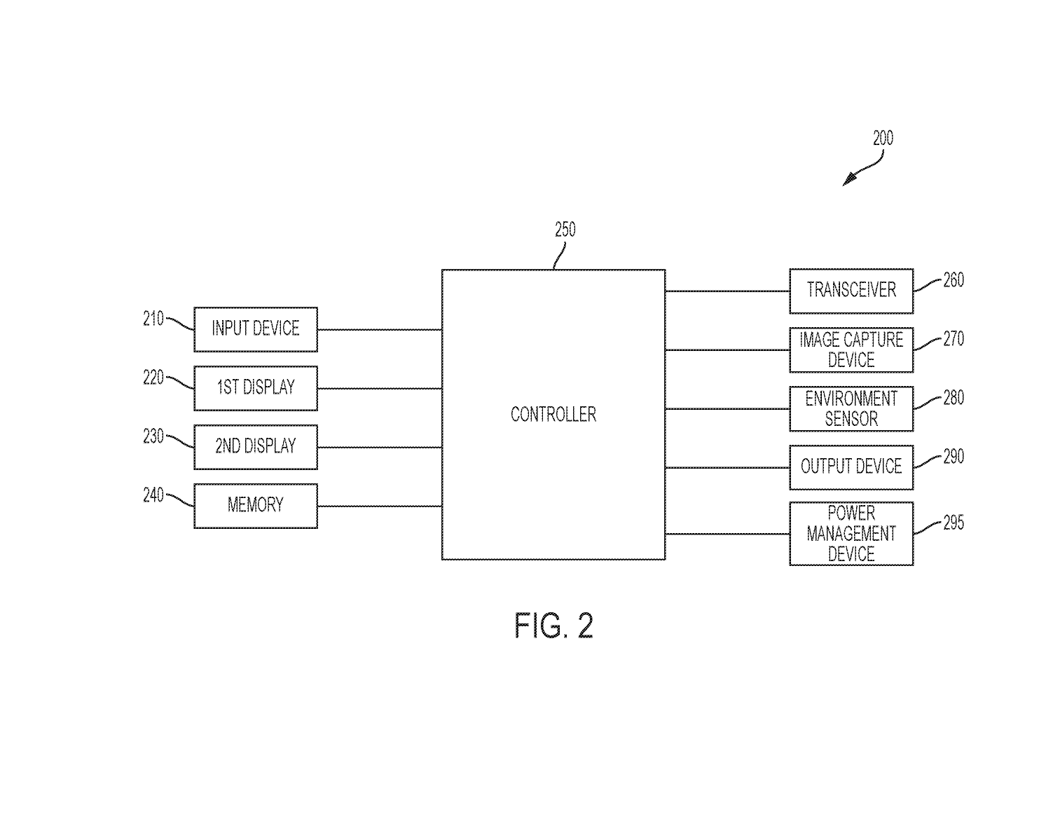

FIG. 2 is a block diagram illustrating a configuration of a portable image device 200 according to an embodiment of the present disclosure.

Referring to FIG. 2, the portable image device 200 includes an input device 210, a first display 220, a second display 230, a memory 240, and a controller 250. In an exemplary embodiment, the portable image device 200 may be portable image device 100.

The input device 210 is configured to receive an input. The input device 210 may include one or more buttons configured to receive an input from the user. In an exemplary embodiment, a user may interact with the input device 210 to turn the portable image device 200 on and off or select and/or search for a menu item or icon. The input device 210 may include one or more different types of input devices. For example, the input device 210 can be a tactile input device such as a button or an audio input device such as a microphone.

When the input device 210 includes at least one button, the button can include one or more of a power button, a volume button, a menu button, a home button, a back button, navigation buttons (e.g., left button, right button, up button, down button, etc.), or a combination thereof. In an exemplary embodiment, the input device 210 may be formed in the housing 120 of the portable image device 100. In an exemplary embodiment, the input device 210 can further include a keypad to receive a key input from the user to control the portable image device 200. The keypad may be a physical keypad coupled with the portable image device 200, a virtual keypad displayed by a projector, or a combination thereof.

When the input device 210 includes a microphone, the microphone generates an electrical signal from a sound wave where the electrical signal indicates an input from the user.

In an exemplary embodiment, the input device 210 may be electrically coupled to and/or integrally formed with the portable image device 200. For example, a button may be disposed on the housing 120 of the portable image device 100. In addition, a microphone may be integrally formed with the housing 120 of the portable image device 100 or it may be electrically coupled to the portable image device where the microphone separate from the housing 120.

The first display 220 is configured to display an image to the user. The first display 220 may be a single display or a plurality of displays configured to display an image to the user. For example, the first display 220 may operate in various modes to generate two-dimensional or three-dimensional images. For example, the first display may include at least one of a display panel, a lens, a laser, and a projector to create two-dimensional or three-dimensional images including holograms.

The second display 230 is configured to display an image external to the portable image device. For example, the image displayed on the second display 230 may be viewed by another party different from the user. The second display 116 may be any type of flat panel display such as a liquid crystal display (LCD), an organic light-emitting diode (OLED) display such as an active-matrix OLED (AM-OLED) or other type of OLED display, a plasma display, etc. In an exemplary embodiment, the second display 230 is a touch sensitive display configured to receive touch inputs.

The memory 240 is configured to store information corresponding to the portable image device 200. The memory 240 includes at least one of a non-transitory computer readable storage medium. In an exemplary embodiment, the memory 240 may include at least one of an external memory device functionally connected with the portable image device 200 and a storage device integrally formed with the portable image device 200 such as a hard drive.

The controller 250 is configured to control one or more operations of the portable image device 200. For example, the controller 250 is coupled to the input device 210, the first display 220, the second display 230, and the memory 240.

In an exemplary embodiment, the portable image device 200 can further include one or more of a transceiver 260, an image capture device 270, an environment sensor 280, an output device 290, and a power management device 295.

The transceiver 260 may be configured to transmit and/or receive signals. In an exemplary embodiment, the transceiver 260 may be used to establish communication with one or more second devices such as an electronic device or a peripheral/auxiliary device. The transceiver 260 may include one or more devices configured to transmit and/or receive short-range and/or long-range communications. For example, short range communications may include at least one of BLUETOOTH, Infrared Data Association (IrDA), Wi-Fi, Near Field Communication (NFC), etc.

In an exemplary embodiment, the transceiver 260 can be configured to receive a message from a second device. For example, the message can be an indication that another party wishes to interact with the user while the portable image device is mounted on a user. Additionally, the transceiver 260 can be configured to transmit a message from the user to another party within a predetermined distance of the user to indicate that the user wishes to interact with the other party while the portable image device is mounted on the user. The messages to and/or from the portable image device can include an indication associated with a degree of importance. For example, the message can indicate that the information contained in the message requires immediate attention, requires attention within a predetermined time, requests a response, and/or provides information not requiring any response.

The image capture device 270 may be configured to capture an image. The image capture device 270 may include one or more cameras such as an infrared camera, an RGB camera, a combination thereof, etc. In an exemplary embodiment, the image capture device 270 includes a first image capture device including one or more cameras orientated such that images associated with the user may be captured and a second image capture device including one or more cameras oriented to capture images associated with an environment external to the portable image device. For instance, the second image capture device may capture images of the environment surrounding the portable image device including an image of another party different from the user. In an exemplary embodiment, the first image capture device can be further configured to perform eye tracking technique such that the image displayed on the first display and/or the image displayed on the second display is based on the results of the eye tracking technique.

The environment sensor 280 is configured to detect a state or surrounding environment of the portable image device. In an exemplary embodiment, the environment sensor 280 detects a state or surrounding environment condition of the portable image device and transmits a signal to the controller 250.

The environment sensor 280 may include one or more sensors. For example, the environment sensor 280 may include a proximity sensor for detecting the user's proximity to the portable image device 200 or the proximity of the portable image device 200 to another party or another object in the environment surrounding the portable image device 200, a motion/orientation sensor to detect a motion (e.g., rotation, acceleration, deceleration, and vibration) of the portable image device 200, an illumination sensor to detect ambient illumination, or a combination thereof. The motion/orientation sensor may include at least one of an acceleration sensor, a gravity sensor, a geomagnetic sensor, a gyro sensor, a shock sensor, a global positioning system (GPS) sensor, and a compass sensor.

The output device 290 is configured to provide information associated with the portable image device. For example, the output device 290 may be a speaker configured to output sound to the user or to another party different from the user.

The power management device 295 is configured to manage the power of the portable image device. For example, the power management device 295 may include a power management integrated circuit (PMIC), a charger IC, a battery, and/or a battery gauge. The battery may store or produce electricity to supply power to the portable image device. The battery gauge measures various attributes of the battery. For example, the battery gauge may be configured to measure the remaining capacity, the voltage, the current, and/or the temperature of the battery. In an exemplary embodiment, an indicator associated with the battery status may be displayed on the first and/or second display of the portable image device.

In operation, the controller 250 is configured to control the first display 220 and/or the second display 230 to display an image. For example, a first image may be displayed on the first display 220 and a second image may be displayed on the second display 230. The first image and the second image may be the same image or a different image.

The controller 250 may be further configured to receive an input. The controller 250 may receive the input from one or more of the input device 210, an input received at the second display 230, the transceiver 260, the image capture device 270, the environment sensor 280, and the power management device 295. In response to the input, the controller 250 may display the second image on the second display 230 based on the input.

The second image may be associated with at least one of a predetermined preference, a detected physical environment, an image display mode, or a gesture. In an exemplary embodiment, a first input device may be associated with the first display 220 and a second input device may be associated with the second display 230.

In addition, the controller 250 may be configured to detect at least one of a movement of the portable image device and a current state of the portable image device. In an exemplary embodiment, an input sensor may be disposed on an external surface of a housing of the portable image device. The input sensor may be configured to detect a gesture of the user or of another party different from the user.

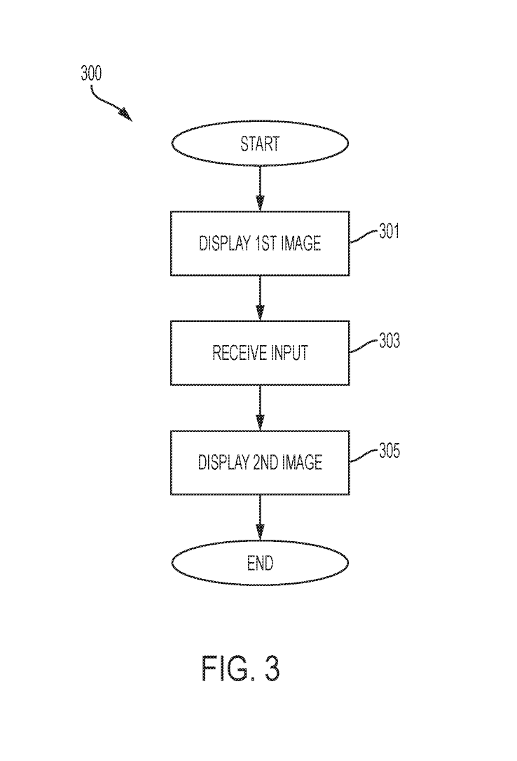

FIG. 3 illustrates a flow chart of an exemplary method 300 of displaying an image on a display of a portable image device. Referring to FIG. 3, the method will be discussed with reference to the exemplary portable image devices 100 and 200 illustrated in FIGS. 1 and 2. However, the method can be implemented with any suitable portable image device. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the method can be omitted, rearranged, combined, and/or adapted in various ways.

At operation 301, an image is displayed on a first display of a portable image device. For example, a first image may be displayed on the first display 220 such that a user of the portable image devices 100, 200 may view the first image.

At operation 303, an input may be received. For example, an input may be received by at least one of the input device 210, the second display 230, the transceiver 260, the image capture device 270, the environment sensor 280, and the power management device 295.

At operation 305, an image is displayed on a second display of the portable image display. For example, a second image may be displayed on the second display 230 such that another party other than the user may view the second image. The second image may be associated with at least one of a predetermined preference, a detected physical environment, an image display mode, or a gesture.

In an exemplary embodiment, the image displayed on the second display of the portable image display may be based on a current battery capacity and/or an estimated remaining capacity of the battery. The power management device 295 can transmit an indication of the current battery capacity and/or an indication of an estimation of the remaining capacity of the battery based on an estimated usage of the portable image device. When the power management device 295 indicates that a first predetermined threshold is met, an image is displayed on the second display as described above.

When the power management device 295 indicates that a second predetermined threshold less than the first predetermined threshold is met, the image may be selectively displayed on the second display. For example, an image may be displayed on the second display after a gesture from another party is received where no image is displayed on the second display to minimize battery consumption. Alternatively, the image may be displayed on the second display intermittently according to a predetermined time threshold. For instance, an image may be displayed on the second display for a first predetermined period and then not displayed during a second predetermined period and then further displayed during a third predetermined period etc. The first predetermined period may be shorter, longer, or the same as the second predetermined period. In addition, the third predetermined period may be the same or different from the first and/or second predetermined period.

When the power management device 295 indicates that a third predetermined threshold less than the first predetermined threshold and the second predetermined threshold is met, the image may be prevented from being displayed on the second display. For example, when the power management device 295 indicates that the amount of power necessary to display the second image may undesirably reduce the power necessary to perform primary functions of the portable image device (e.g., displaying images on the first display, etc.), the controller 250 can determine to discontinue displaying images on the second display. In addition, an indication of whether or not images are displayed on the second display may be provided to the user.

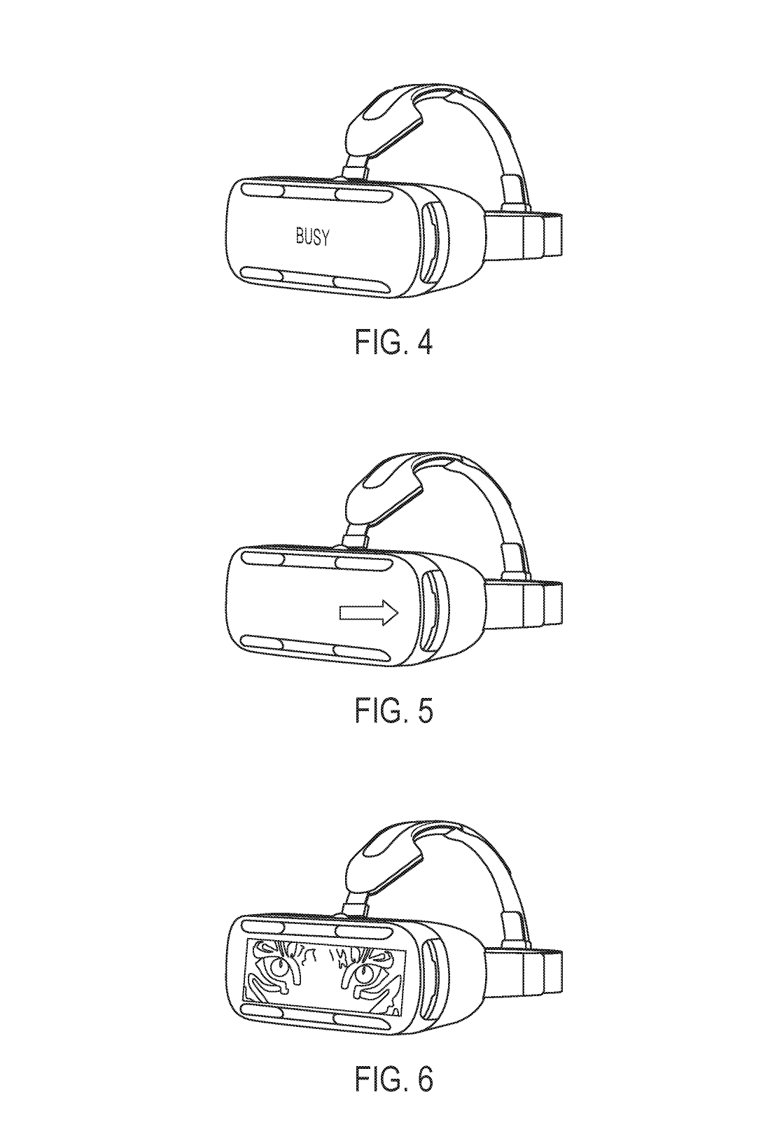

FIGS. 4-7 illustrate examples of images displayed on a display of a portable image device according to various embodiments of the present disclosure.

Referring to FIG. 4, an image displayed on a second display of the portable image device may include various alphanumeric characters. Any alphanumeric character may be displayed including a single character, a word, or a sentence. For example, the image displayed in the second display may include an identification of a user of the portable display device such as a name. The image displayed on the second display may also include an indication of a current status of a user of the portable image display such as Available or Busy, as illustrated in FIG. 4.

Referring to FIG. 5, the image displayed on the second display of the portable image device may alternatively include symbols or images. Any symbol or image may be displayed. For example, as illustrated in FIG. 5, the image can include an arrow. In an exemplary embodiment, the arrow may be indicative of a general direction in which a user of the portable image device is moving where the arrow is displayed based on information detected using one or more of the input device 210, the image capture device 270, the transceiver 260, and the environmental sensor 280. In another exemplary embodiment, the symbol or image displayed on the second display of the portable image device may allow other persons in proximity of the user of the portable image device to identify which path the user is on in an alternative reality (AR) space.

Referring to FIG. 6, the image displayed on the second display of the portable image device may include an image, a video, etc. Any image, video, etc. may be displayed. In an exemplary embodiment, the image may include a predetermined image such as a comic book character, an image associated with a movie, a facial distortion image, etc. In another exemplary embodiment, the image may be based on a current environment of the user. For example, if it is determined that the user is in a first location such as a train station, an image associated with the train station may be displayed on the second display. Alternatively, if it is determined that the user is in a second location such as an office, an image associated with the office may be displayed on the second display. The determination of location associated with the portable image device 200 may be based on an input detected by one or more of the input device 210, an input received at the second display 230, the transceiver 260, the image capture device 270, and the environment sensor 280.

In another exemplary embodiment, the image displayed on the second display of the portable image device may be based on facial recognition of another person. For instance, the image capture device 270 oriented external to the portable image device may capture the image of another party different from the user where a predetermined image may be correlated to the other party and stored in the memory 240. When the portable image device identifies the other party, the predetermined image associated with the other party is retrieved from the memory 240 and displayed on the second display 230. The predetermined image associated with the other party may be set based on the preferences of the user of the portable image display.

Referring to FIG. 7, the image displayed on the second display of the portable image device may be associated with the user of the portable image display device. In an exemplary embodiment, the image displayed on the second display device may be an image or a video feed of the user's face. For example, the portable image display device may be in pass-through mode when the image associated with the user of the portable image display device is displayed. The image displayed on the second display may indicate that the user is in a pass-through mode rather than a pure virtual reality mode. Alternatively, the image displayed on the second display of the portable image device may be the same as the image displayed on the first display of the portable image device such that another party different from the user may see what the user is seeing on the first display. In another exemplary embodiment, the image associated with the user may be a real-time image of the user from the first image capture device. The real-time image may include various markings associated with the user including naturally occurring markings such as freckles, pimples, scars, etc. as well as tattoos or other identifiers formed on the face of the user. The controller 250 may enhance the real time image by removing one or more the various markings associated with the user's face prior to displaying the image on the second display.

In an exemplary embodiment, the image capture device 270 orientated to capture an image external to the portable display device may be used to provide feedback to the user of the portable image device associated with the current environment. For example, a first image corresponding to the current environment may be displayed to the user on the first display 220 and a second image associated with the user may be displayed on the second display 230 to provide an indicator to another party that the user can see the physical space around them. In addition, the image displayed on the second display 230 may be generated based on eye-tracking techniques such that it may appear as if the user is directly looking at the other person. Alternatively, the image displayed on the second display 230 may mimic that the user is directly looking at the other person even if the eye-tracking techniques indicate that the user is looking in a direction different from the other person.

In another exemplary embodiment, the image displayed on the second display of the portable image device may prompt another party to respond. For example, the image may include a question such as “Do you want to talk?” in order to minimize any undesirable interruptions to the user. The other party may gesture or respond through a respective portable image device.

When the second display is a touch input display, another party different from the user may direct where the user may look or work within the VR/AR screen and/or a current environment based on an input detected. For example, the other party may provide an input to the portable image display indicating that the user should physically walk in a first direction or that the user to maneuver in the first direction within the VR/AR environment. The input may be received at the second display or using the transceiver of the portable image display device.

When another party different from the user wishes to contact or interact with the user of the portable image device, various inputs may be received from image capture devices and/or proximity sensors. For example, the presence of another party different from the user may be detected by the image capture device 270 and/or an environment sensor 280 (e.g., a proximity sensor) when the other party different from the user comes within a predetermined distance of the user of the portable image device 200. A gesture of the other party or the user may be detected as an input using the image capture device 270 and/or the environment sensor 280. In an exemplary embodiment, a horizontal wave indicates a general greeting requiring no response by the user. Alternatively, a vertical wave indicates that a response is expected. When the input gesture is detected, the controller 250 may provide an indication to the user of the portable image device 200 such as displaying an indicator on the first display 220 and/or providing an output through the output device 290. The user may respond to the indication by changing modes (e.g., active to pass-through mode), by providing an input using the input device 210, or by modifying the image displayed on the second display 230.

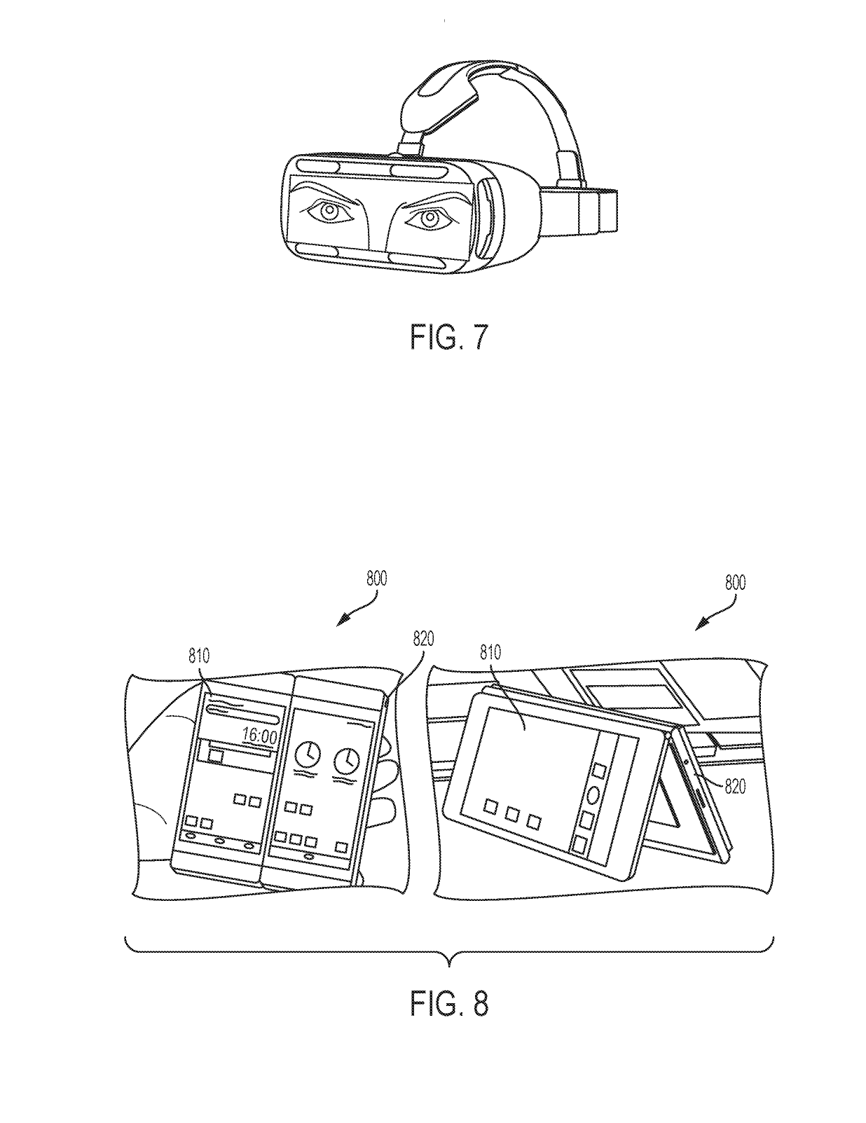

FIG. 8 illustrates an exemplary display of a portable image device according to various embodiments of the present disclosure.

Referring to FIG. 8, an electronic device 800 having dual screens may be used as the first display and the second display. In an exemplary embodiment, the electronic device 800 may open like a book and include a first screen 810, and a second screen 820.

The electronic device 800 may be configured to establish communications with the portable image device in various ways. For example, the electronic device 800 may communicate with the portable image device via the transceiver using short range communications such as Bluetooth and NFC.

When the first screen 810 and the second screen 820 of the electronic device 800 are folded over, the first screen 810 of the electronic device 800 may be implemented as the first display 220 and the second screen 820 of the electronic device 800 may be implemented as the second display 230. In an exemplary embodiment, the first screen 810 and the second screen 810 of the electronic device may be configured to perform different functions and/or have various functions disabled after the electronic device 800 is in communication with the portable image device. For example, the first screen 810 may be configured to only display images to the user based on the VR/AR environment while the second screen 820 may be configured to display images external to the portable image device as well as receive inputs at the second screen 820.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents. Various embodiments of the present disclosure are described as examples only and are noted intended to limit the scope of the present disclosure. Accordingly, the scope of the present disclosure should be understood as to include any and all modifications that may be made without departing from the technical spirit of the present disclosure.

What is claimed is:

1. A portable image device, the device comprising:
a housing coupled to a support;
a first display disposed within the housing;
a second display disposed on an external surface of the housing; and
a controller configured to:
display a first image on the first display, and
display a second image on the second display.

2. The device of claim 1, wherein the first image and the second image are the same.

3. The device of claim 1, wherein the first image and the second image are different.

4. The device of claim 1, wherein the controller is further configured to:
receive an input, and
display the second image on the second display based on the input.

5. The device of claim 1, wherein the second image is associated with at least one of a predetermined preference, a detected physical environment, an image display mode, or a gesture.

6. The device of claim 1,
wherein the controller is further configured to detect at least one of a movement of the portable image device and a current state of the portable image device, and
wherein the second image is based on the detected movement or the current state of the portable image device.

7. The device of claim 1, further comprising:
an input sensor disposed on the external surface of the housing, the input sensor configured to detect a gesture,
wherein the second image is based on the detected gesture.

8. The device of claim 1,
wherein the second display is configured to receive a touch input, and
wherein the second image is based on the touch input.

9. The device of claim 1, further comprising:
a transceiver configured to transmit and receive signals,
wherein the controller is further configured to establish communication with a second device using the transceiver.

10. The device of claim 1, further comprising:
a first input device associated with the first display; and
a second input device associated with the second display.

11. A method of displaying an image on a portable image device, the method comprising:
displaying a first image on a first display of the portable image device; and
displaying a second image on a second display of the portable image device,
wherein the first display is disposed on an inner surface of a housing of the portable image device, and
wherein the second display is disposed on an external surface of the housing of the portable image device.

12. The method of claim 11, wherein the first image and the second image are the same.

13. The method of claim 11, wherein the first image and the second image are different.

14. The method of claim 11, further comprising:
receiving an input,
wherein the second image is based on the input.

15. The method of claim 11, wherein the second image is associated with at least one of a predetermined preference, a detected physical environment, an image display mode, or a gesture.

16. The method of claim 11, further comprising:
detecting at least one of a movement of the portable image device and a current state of the portable image device,
wherein the second image is based on the detected movement or the current state of the portable image device.

17. The method of claim 11, further comprising:
detecting a gesture using an input sensor,
wherein the input sensor is disposed on the external surface of the housing.

18. The method of claim 11, further comprising:
receiving a touch input at the second display,
wherein the second image is based on the touch input.

19. The method of claim 11, further comprising:
establishing communication with a second device using a transceiver configured to transmit and receive signals.

20. The method of claim 11, further comprising:
receiving a first input associated with the first display; and
receiving a second input associated with the second display,
wherein the displaying of the second image is based on the first input and the second input.
